(19) United States
(12) Patent Application Publication
(10) Pub. No.: US 2012/0324772 A1
(43) Pub. Date: Dec. 27, 2012

(54) LED LIGHT FIXTURE WITH PRESS-FIT FIXTURE HOUSING HEAT SINK

(76) Inventor: Sherman Gingerella, Carlsbad, CA (US)

(21) Appl. No.: 13/167,046

(22) Filed: Jun. 23, 2011

(51) Int. Cl. G09F 13/00; F21S 8/04; F21S 8/00; E05B 17/10; F21V 5/04; F21V 14/06; F21V 29/00; F21S 8/02

(52) U.S. Cl. 40/559; 362/373; 362/147; 362/364; 362/100; 362/311.02; 362/280

(57) ABSTRACT

An LED light fixture. A fixture housing includes a socket-receiving cutout section. A socket is held within the socket-receiving cutout section. An LED circuit board is connected to an LED circuit board holder. The LED circuit board holder includes an insertion piece. The insertion piece is inserted into the socket-receiving cutout section and fits over the socket so that the connection pins from the LED circuit board are inserted into the socket. The insertion piece is press-fit into the socket-receiving cutout section and is held in place by friction force between the insertion piece and the socket-receiving cutout section. A thermally conductive pathway is established between the LEDs on the LED circuit board, the circuit board holder and the fixture housing. Heat generated by the LEDs travel through the circuit board and through the fixture housing. In a preferred embodiment a T-slot is cut into the insertion piece to make it more bendable and to facilitate its insertion and removal from the socket-receiving cutout section.

The present invention relates to lamps, and in particular to LED light fixtures.

### BACKGROUND OF THE INVENTION

Outdoor landscape lighting is extremely popular for both residences and businesses in modern society. An outdoor landscape lighting system typically utilizes a transformer to reduce standard voltage from 120 volts to a safe 12 volts in order to eliminate risk of electric shock to children or animals if the cable is accidentally cut.

### Halogen Lamp

FIG. 1 shows an exploded view of prior art halogen light fixture 1 of the type typically used for landscape lighting. Halogen filament 4 is mounted inside lamp reflector 2. Power pins 3 extend downward from lamp holder 2a. Socket 5 is mounted into light fixture 6. Socket 5 shields cord 7 from heat of filament 4. Cord 7 extends from socket 5 and is connected to a low voltage AC source. Shroud 8 with glass lens 9 attaches to the top of fixture 6 and covers and protects lamp 4b. FIG. 2 shows an assembled view of prior art halogen light fixture 1.

Halogen light fixture 1 is very popular and widely available. However, halogen lamp 4 gets very hot, has a relatively short life span and has to be replaced frequently.

### Light Emitting Diode (LED) Retrofit Lamp

FIG. 3 shows prior art halogen light fixture 11 with LED retrofit lamp 12. Because an LED lamp has a longer life span than a corresponding halogen lamp, a prior art solution for the short life of the halogen lamp is to replace the lamp with LED lamp 12. An LED lamp will last longer provided that the bulb is operated within specific parameters. LED lamps are sensitive to high temperatures. Unfortunately, heat is trapped by shroud 8 and blocked by socket 5. The high temperature can quickly degrade LED lamp 12 causing it to fail or perform poorly.

### LED Light Fixture with Fixture Housing Heat Sink

FIG. 4 shows an exploded view of LED light fixture 15. LED light fixture 15 includes fixture housing 16, LED circuit board 17 with LEDs 23, screws 19, optics 20, shroud 21 and fitting 22. In FIG. 4, LED circuit board 17 is screwed onto brass fixture housing 16. Optics 20 align and rest on LED circuit board and is held in place by shroud 21. Unlike light fixture 11 (FIG. 3), significant heat is not retained in the air adjacent LEDs 23. Rather, fixture housing 16 becomes a heat sink and the heat is dissipated through fixture housing 16 and travels downward away from LEDs 23. Longer life and better performance for the LEDs are achieved. However, light fixture 15 can be difficult and time consuming to initially fabricate and difficult to service if a replacement of LED circuit board 17 is required. Screws 19 can become misaligned, lost and corroded. Also, LED circuit board 17 can be improperly installed resulting in damage during the installation process. It is particularly difficult to attach screws 19 during a field servicing of LED light fixture 15 where the lamp servicer may have to contend with less than optimum conditions during the servicing operation.

What is needed is a better LED light fixture.

### SUMMARY OF THE INVENTION

The present invention provides an LED light fixture. A fixture housing includes a socket-receiving cutout section. A socket is held within the socket-receiving cutout section. An LED circuit board is connected to an LED circuit board holder. The LED circuit board holder includes an insertion piece. The insertion piece is inserted into the socket-receiving cutout section and fits over the socket so that the connection pins from the LED circuit board are inserted into the socket. The insertion piece is press-fit into the socket-receiving cutout section and is held in place by friction force between the insertion piece and the socket-receiving cutout section. A thermally conductive pathway is established between the LEDs on the LED circuit board, the circuit board holder and the fixture housing. Heat generated by the LEDs travel through the circuit board and through the fixture housing. In a preferred embodiment a T-slot is cut into the insertion piece to make it more bendable and to facilitate its insertion and removal from the socket-receiving cutout section.

### BRIEF DESCRIPTION OF THE DRAWINGS

FIGS. 1-4 show prior art lamps.

FIGS. 5-18 show a preferred embodiment of the present invention.

FIG. 19 shows another preferred embodiment of the present invention.

FIGS. 20-24 show preferred uses of preferred embodiments of the present invention.

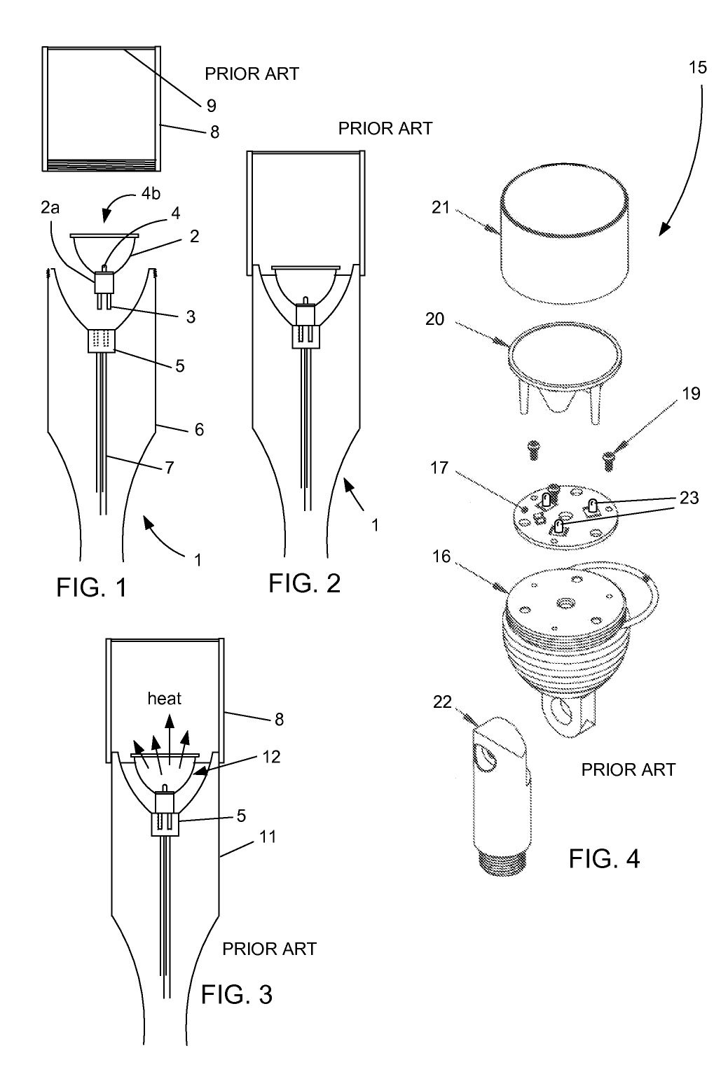

### DETAILED DESCRIPTION OF THE PREFERRED EMBODIMENTS

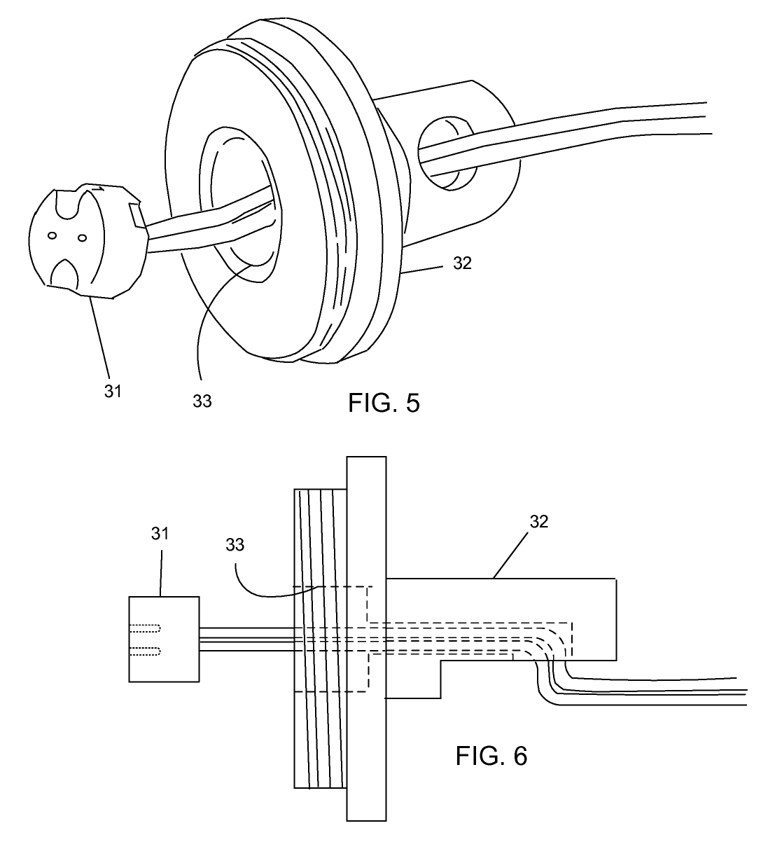

FIG. 5 shows a perspective view and FIG. 6 shows a side view of socket 31 inserted through fixture housing 32. Fixture housing 32 includes socket-receiving cutout section 33. Socket-receiving cutout section 33 preferably has a circular cross section with a diameter large enough and a depth deep enough to fully receive socket 31.

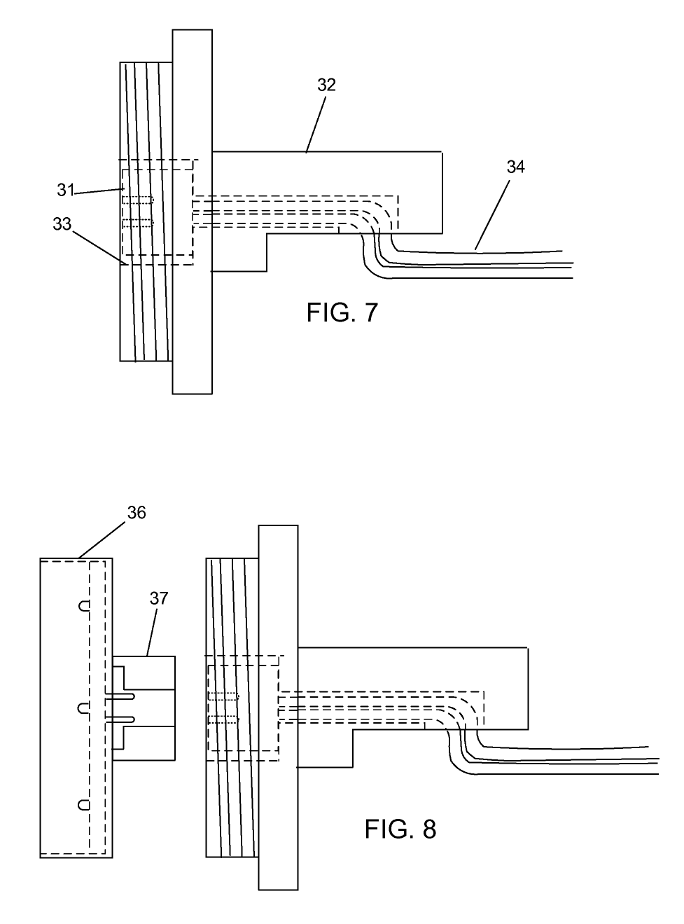

In FIG. 7, wire 34 has been pulled to the right and socket 31 has been pulled into socket-receiving cutout section 33 of fixture housing 32.

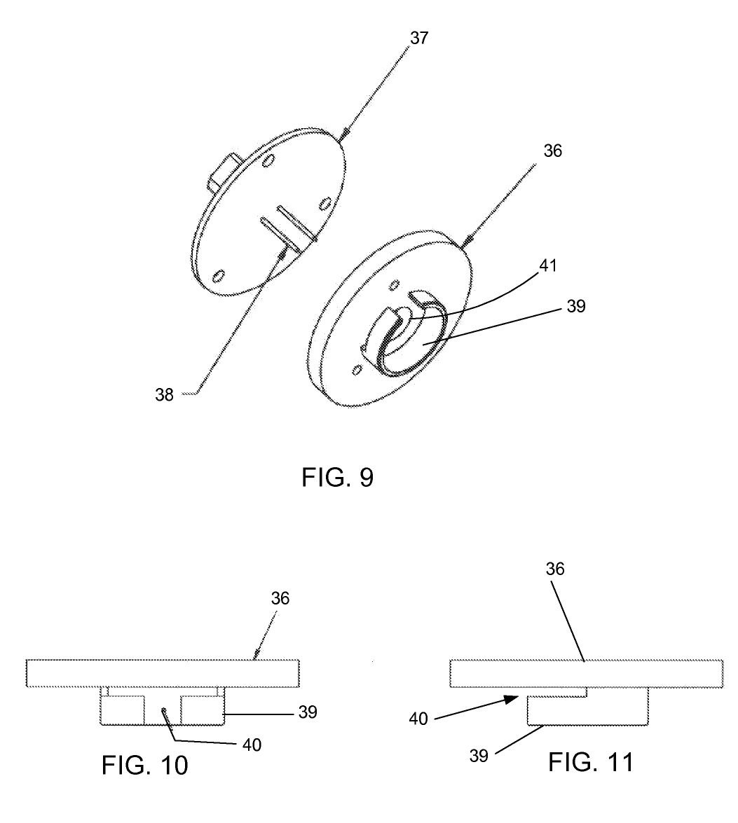

In FIG. 8, LED holder 36 has been positioned to the left of fixture housing 32. LED holder 36 is preferably fabricated from aluminum (FIGS. 9-11). LED circuit board 37 is mounted to the top of LED holder 36 with thermally conductive interface. Pins 38 extend through hole 41 and allow for electrical connection to socket 31.

LED holder 36 includes tubular insertion piece 39 attached to its bottom. T-slot 40 is preferably cut into insertion piece 39. T-slot 40 makes it easier to bend insertion piece 39 as it is inserted into socket-receiving cutout section 33 of fixture housing 32.

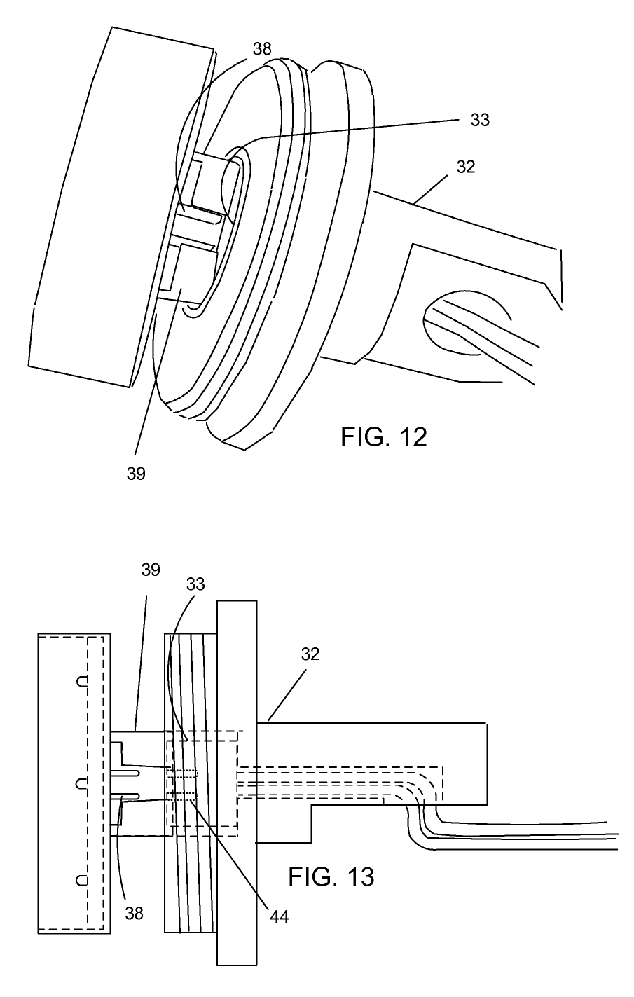

In FIGS. 12 and 13, insertion piece 39 has been partially inserted into socket-receiving cutout section 33 of fixture housing 32. Insertion piece 39 presses tightly against the sides of socket-receiving cutout section 33 causing insertion piece to bend slightly as it is being inserted to accommodate the size of the socket-receiving cutout section. Insertion piece 39 fits around socket 33 as it is being inserted. Pins 38 are properly aligned with socket holes 44 for insertion as holder 36 is being inserted into socket-receiving cutout section 33.

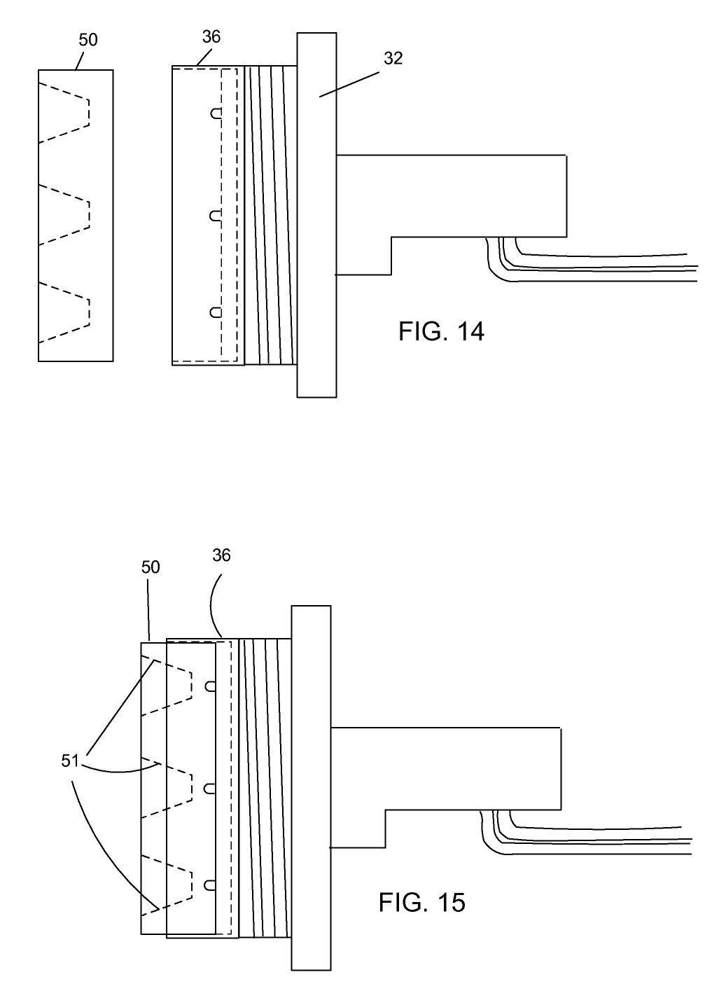

In FIG. 14, insertion piece 39 has been fully press-fit and inserted into socket-receiving cutout section 33 of fixture housing 32 and optics section 50 is positioned next to holder 36. The bendability of insertion piece 39 (which has been increased by the utilization of T-slot 40 as explained above) has increased the ease of insertion.

Once inserted into socket-receiving cutout section 33, a friction force between insertion piece 39 and socket-receiving cutout section 33 holds holder 36 tightly in place against fixture housing 32. As shown in FIG. 14, there is now a thermally conductive pathway for heat to travel to the right from LEDs 47 through fixture housing 32 (which now functions as a very efficient heat sink). The friction force maintaining holder 36 tightly in place against fixture housing 32 is of sufficient strength such that holder 36 will be retained in this position during operation of the lamp. However, the friction force can be easily overcome by a user manipulating holder 36 and fixture housing 32 with his fingers and hands in a fashion similar to that described above.

In FIG. 15, optics section 50 has been press fit onto holder 36 so that optical lenses 51 are positioned over LEDs 47. Friction force between optics section 50 and holder 36 holds optics section 50 in place against holder 36.

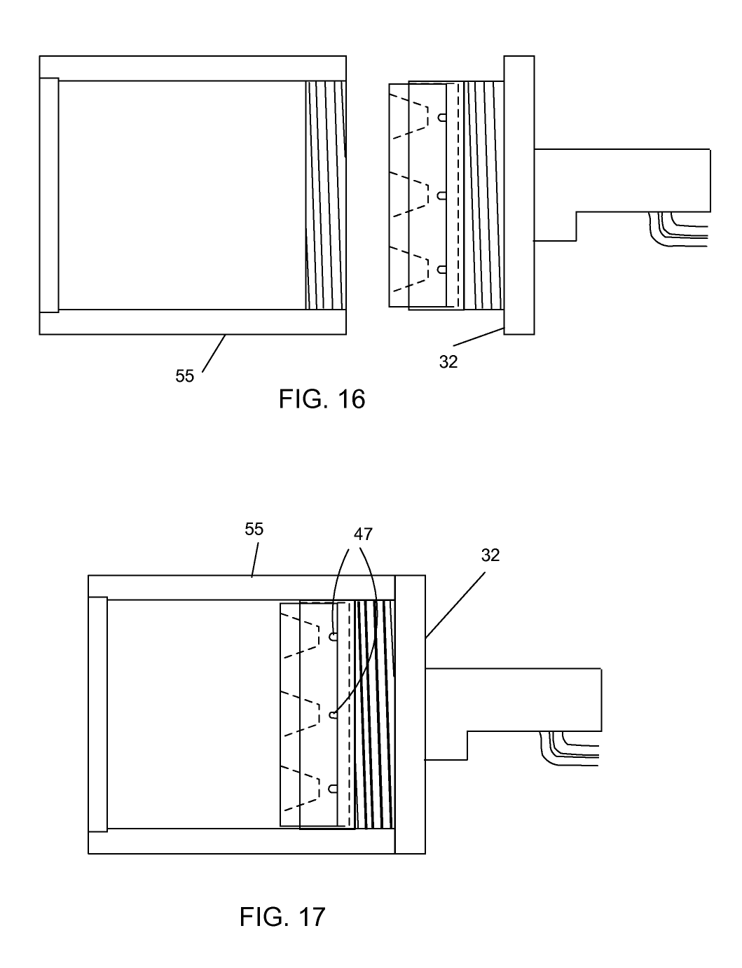

In FIG. 16, shroud 55 has been positioned next to fixture housing 32. In FIG. 17, shroud 55 has been threaded onto fixture housing 32. LEDs 47 are now enclosed within shroud 55.

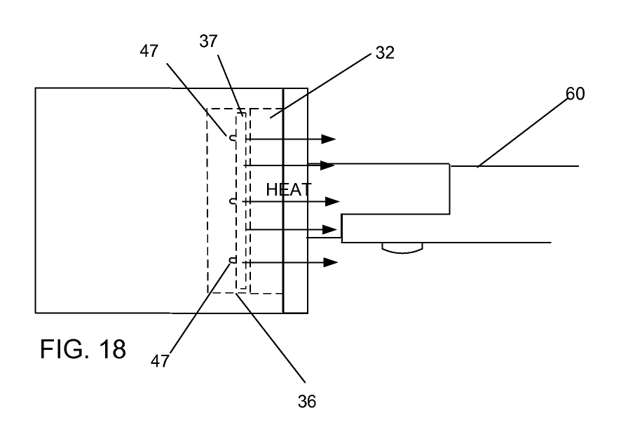

In FIG. 18, fitting 60 has been attached to fixture housing 32. Fixture housing 32 is shown functioning as a heat sink. Heat generated by LEDs 47 travels through LED circuit board 37 to holder 36 to fixture housing 32 and through fitting 60 and out into the surrounding environment. Very little heat is retained within shroud 55. This allows LEDs 47 to operate at higher temperatures and for longer periods of time with little or no degradation.

### Other Preferred Embodiment

The preferred embodiment shown in the above figures recognizes that for an AC power source it is unimportant how pins 38 insert into socket holes 44. However, for a DC power source it is important that the pins are properly inserted into the socket to establish the correct polarity.

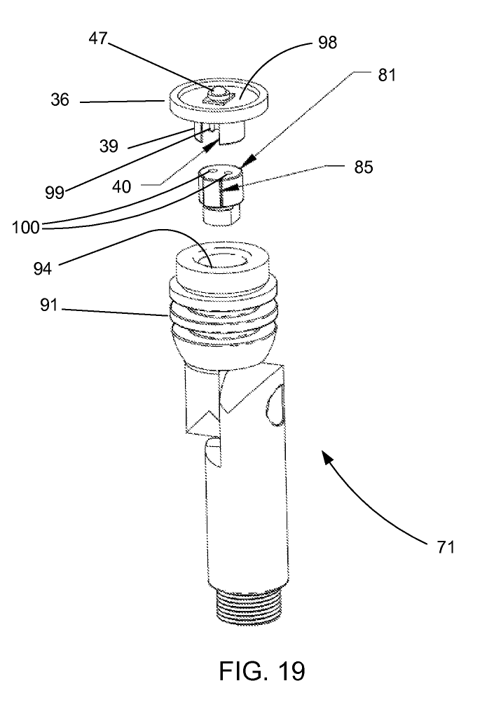

For example, FIG. 19 shows DC lamp 71. LED 47 is mounted to LED circuit board 98. LED circuit board 98 is mounted to holder 36. Insertion piece 39 extends downward from holder 36 and includes T-slot 40. Socket 81 fits inside socket-receiving cutout section 94 of fixture housing 91. Socket 81 includes key 85. Key 85 is positioned such that it forces pins 99 to properly align with holes 100 to establish the correct polarity for the DC connection.

### Alignment for Optics

In a preferred embodiment optics section 30 includes an alignment feature so that the optics lenses are properly positioned over the LEDs. For example, FIG. 25 shows optics section 83 with alignment groove 84 positioned over holder 96 with alignment tongue 97.

FIGS. 26-28 illustrate how the optics alignment feature is used. FIG. 26 shows LED circuit board 77 with LEDs 23 mounted and groove 76. FIG. 27 shows LED circuit board 77 inserted into holder 96. Groove 76 has been aligned with tongue 97 so LEDs 23 are aligned as shown. FIG. 28 shows optics section 83 inserted into holder 96 over LED circuit board 77. Groove 84 has been aligned with tongue 97 so that optics lenses 85 are aligned over LEDs 23 as shown.

### Preferred Uses

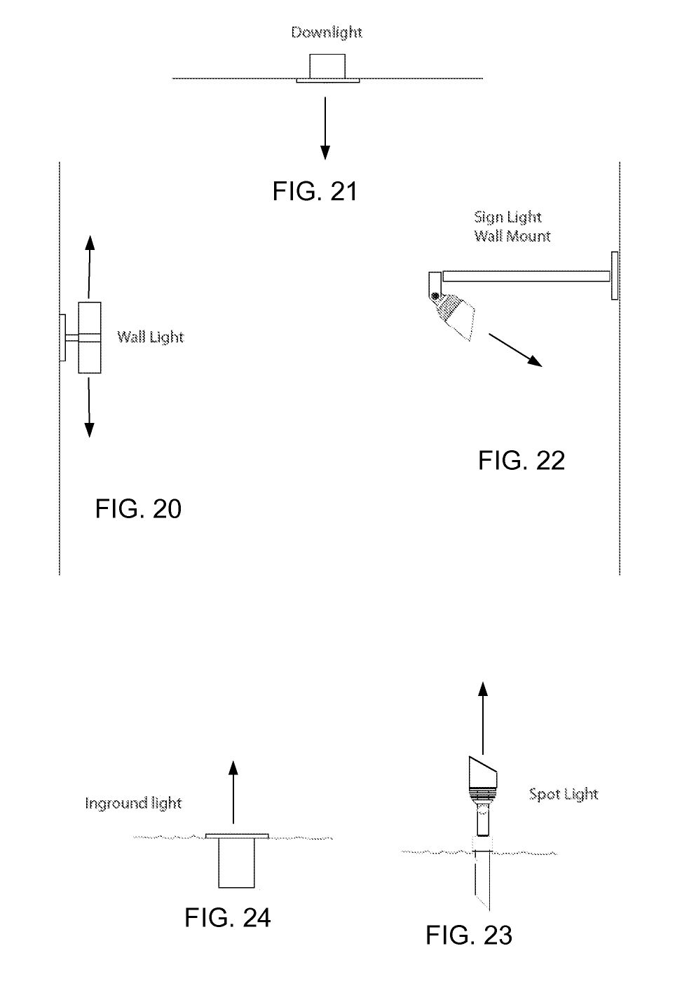

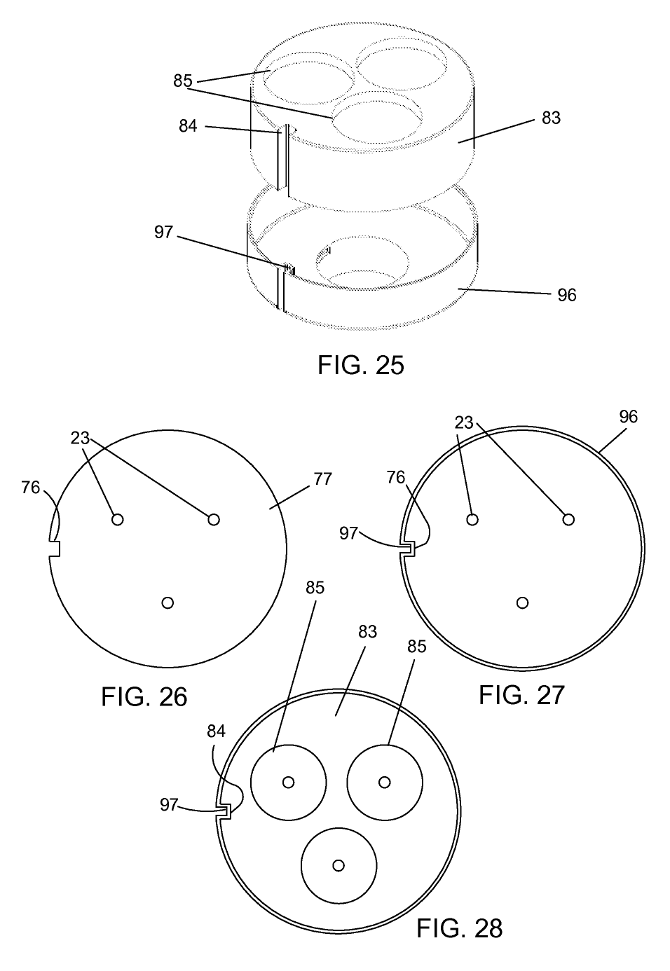

While the above description discussed the preferred utilization of the present invention for outdoor landscape lighting, it should be understood that the present invention can be utilized for virtually any type of lamp. For example, FIGS. 20-24 show a variety of uses for a lamp in which holder 36 includes an insertion piece that has been press fit into a fixture housing for the purpose of providing a heat sink. In each of the embodiments shown in FIGS. 20-24, the LED circuit board operates at a low temperature allowing for longer lamp operations without needing to repair or replace the lamp.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

What is claimed is:

1) An LED light fixture, comprising:
A) a socket,
B) a fixture housing comprising a socket-receiving cutout section, wherein said socket is received within said socket-receiving cutout section,
C) an LED circuit board holder comprising,
i) an insertion piece inserted into said socket-receiving cutout section over said socket, wherein said insertion piece is press-fit into said socket receiving cutout section and wherein said insertion piece is held in place by friction force between said insertion piece and said socket-receiving cutout section,
ii) an LED circuit board connected to said LED circuit board holder, said LED circuit board comprising
a) connection pins inserted into said socket,
b) at least one LED,
wherein a thermally conductive pathway is established between said LED circuit board, said LED circuit board holder and said fixture housing and wherein heat generated by said at least one LED travels from said at least one LED through said circuit board holder and through said fixture housing.

2) The LED light fixture as in claim 1, further comprising a shroud covering said at least one LED and threaded onto said fixture housing.

3) The LED light fixture as in claim 1 further comprising a fitting attached to said fixture housing.

4) The LED light fixture as in claim 1 wherein said socket-receiving cutout section comprises a circular cross section.

5) The LED light fixture as in claim 1, wherein said insertion piece is tubular and comprises a cut to make said insertion piece more bendable.

6) The LED light fixture as in claim 1, wherein said cut is in the general shape of a T-slot.

7) The LED light fixture as in claim 1, wherein said LED light fixture is mounted to a ceiling and is configured to operate as a down light.

8) The LED light fixture as in claim 1, wherein said LED light fixture is mounted to a wall and is configured to operate as a wall light.

9) The LED light fixture as in claim 1, wherein said LED light fixture is mounted to a wall and is configured to operate as a sign light.

10) The LED light fixture as in claim 1, wherein said LED light fixture is mounted to the ground and is configured to operate as a spot light.

11) The LED light fixture as in claim 1 wherein said LED light fixture is mounted to the ground an is configured to operate as an in ground light.

12) The LED light fixture as in claim 1, wherein said insertion piece and said socket comprise a key so that the correct polarity is established between said connection pins and said socket.

13) The LED light fixture as in claim 1, wherein said key comprises a slot cut into said insertion piece and an extension formed into said socket, wherein said extension and said slot align to establish said correct polarity.

14) The LED light fixture as in claim 1, further comprising at least one optical lens covering said at least one LED.

15) The LED light fixture as in claim 14, wherein said at least one optical lens and said at least one LED comprise an alignment feature for properly aligning said at least one optical lens over said at least one LED.

16) The LED light fixture as in claim 1, wherein said alignment feature is a tongue and groove alignment feature.
